(19) United States
(12) Patent Application Publication
(10) Pub. No.: US 2025/0316685 A1
(43) Pub. Date: Oct. 9, 2025

(54) POSITIVE ELECTRODE ACTIVE MATERIAL FOR LITHIUM BATTERY AND MANUFACTURING METHOD THEREOF

(71) Applicants: Hyundai Motor Company, Seoul (KR); Kia Corporation, Seoul (KR); Research & Business Foundation Sungkyunkwan University, Suwon (KR)

(72) Inventors: Jeong Hyun Seo, Dajeon (KR); Hong Seok Min, Seoul (KR); Sung Woo Noh, Seoul (KR); Je Sik Park, Seoul (KR); Im Sul Seo, Cheongju, Chungcheongbuk-do (KR); Yong Seok Lee, Suwon (KR); Joo Young Lee, Pyeongtaek (KR); Ju Yeong Seong, Seongnam (KR); Chung Bum Lim, Suwon (KR); Won Sub Yoon, Suwon (KR); Jang Whan Seok, Suwon (KR); Hyun Beom Lee, Suwon (KR)

(21) Appl. No.: 18/820,461

(22) Filed: Aug. 30, 2024

(30) Foreign Application Priority Data
Apr. 4, 2024 (KR) 10-2024-0045688

(51) Int. Cl. H01M 4/36; C01G 33/00; C01G 53/00; H01M 4/02; H01M 4/131; H01M 4/525; H01M 4/62; H01M 10/0525; H01M 10/42

(52) U.S. Cl. CPC H01M 4/366; C01G 33/00; C01G 53/50; H01M 4/131; H01M 4/525; H01M 4/62; H01M 10/0525; H01M 10/4235; C01P 2002/50; C01P 2004/50; C01P 2004/61; C01P 2004/84; C01P 2006/40; H01M 2004/028

(57) ABSTRACT

A positive electrode active material for a lithium secondary battery comprises a core component with a lithium transition metal oxide and a coating layer on the core component's surface. The material meets the condition 0.5<A/B<0.8, where A is the normalized intensity of the L3 high peak in a Ni L3-edge spectrum of the positive electrode active material, and B is the normalized intensity of the L3 high peak in a Ni L3-edge spectrum of the core component. The invention includes a positive electrode for a lithium secondary battery, comprising the described active material and a sulfide-based solid electrolyte, and optionally a conductive material. Additionally, a lithium secondary battery comprises the positive electrode active material. The manufacturing method involves preparing the core component, mixing it with a coating precursor to form a starting material, and thermally treating the starting material to form the positive electrode active material, ensuring the condition 0.5<A/B<0.8 is met.

### CROSS REFERENCE TO RELATED APPLICATION

The present application claims under 35 U.S.C. § 119 (a) the benefit of Korean Patent Application No. 10-2024-0045688, filed Apr. 4, 2024, the entire contents of which are incorporated herein for all purposes by this reference.

### BACKGROUND

### Technical Field

The present disclosure relates to a positive electrode active material for a lithium secondary battery, comprising a core component of lithium transition metal oxide and a coating layer on the core component's surface. This material satisfies specific conditions determined by X-ray absorption spectroscopy (XAS) for optimal battery performance. The present disclosure also includes a manufacturing method that involves preparing the core component, mixing it with a coating precursor, and thermally treating the mixture to produce the coated material. This method ensures high coating quality, improved capacity, and increased efficiency, making it ideal for advanced all-solid-state battery applications.

### Background

Rechargeable secondary batteries are extensively used in small electronic devices such as mobile phones and laptops, as well as in large applications such as hybrid vehicles and electric vehicles. Accordingly, there is an ongoing need to develop a secondary battery with enhanced stability and higher energy density.

Existing secondary batteries have been made of cells based on organic solvents (i.e., organic liquid electrolytes), so there are limitations in improving stability and energy density of the existing secondary batteries.

All-solid-state batteries using solid electrolytes have recently been in the spotlight because these batteries are based on a technology that does not use organic solvents and thus the cells thereof can be manufactured in a safer and simpler form.

However, in all-solid-state batteries, there is a problem that positive electrodes are deteriorated by a side reaction between positive electrode active materials and sulfide-based solid electrolytes. To mitigate these side reactions, it is essential to coat the surfaces of the positive electrode active materials. The performance, however, can vary greatly depending on the structure, composition, and other characteristics of the coating layer.

In addition, it is difficult to detect and analyze elements of the coating layer having a thickness of several nm. Although the coating quality of the positive electrode active material can be verified through cell evaluation, it takes a lot of time, and it is difficult to check a problem with the coating layer.

### SUMMARY

Accordingly, the present disclosure has been made keeping in mind the above problems occurring in the related art, and an objective of the present disclosure is to provide a positive electrode active material for a lithium secondary battery and a manufacturing method of the positive electrode active material having an excellent coating quality.

Another objective of the present disclosure is to provide objective of the present disclosure is to provide a positive electrode active material for a lithium secondary battery and a manufacturing method of the positive electrode active material in which the coating quality is capable of being more easily checked.

The objectives of the present disclosure are not limited to the foregoing. The objectives of the present disclosure will be able to be clearly understood through the following description and to be realized by the means described in the claims and combinations thereof.

According to an embodiment of the present disclosure, there is provided a positive electrode active material for a lithium secondary battery, the positive electrode active material including: a core component including a lithium transition metal oxide; and a coating layer that coats a surface of the core component, wherein the positive electrode active material may satisfy Condition 1 below.

$$0.5 < A / B < 0.8 \qquad [ Condition 1 ]$$

A may be an intensity of an L3 high peak when a Ni L3-edge spectrum secured by analyzing the positive electrode active material by using an X-ray absorption spectroscopy is normalized.

B may be an intensity of an L3 high peak when a Ni L3-edge spectrum secured by analyzing the core component by using the X-ray absorption spectroscopy is normalized.

In some embodiments, the positive electrode active material may satisfy Condition 2:

$$0.6 < A / B < 0.8 . \qquad [ Condition 2 ]$$

In some embodiments, the positive electrode active material satisfies Condition 3:

$$0.65 \leq A / B \leq 0.7 7 . \qquad [ Condition 3 ]$$

The core component may be in the form of a secondary particle in which primary particles including the lithium transition metal oxide are agglomerated. The primary particles may be formed of a single grain or a plurality of grains. The average particle diameter (D50) of the core component may be between 1 μm and 20 μm.

The core component may include the lithium transition metal oxide represented by Chemical Formula 1 below.

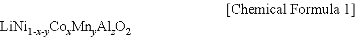

Chemical Formula 1 may satisfy 0<x<0.25, 0<y<0.2, 0≤z<0.15, and x+y+z≤0.4.

The coating layer may include a compound represented by Chemical Formula 2 below.

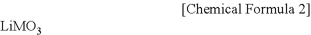

In Chemical Formula 2, the M may include at least one selected from the group consisting of niobium (Nb), tantalum (Ta), boron (B), zirconium (Zr), phosphorus (P), and a combination thereof.

The positive electrode active material may include: at least about 98% by weight and less than about 99% by weight of the core component; and more than about 1% by weight and equal to or less than about 2% by weight of the coating layer.

According to an embodiment of the present disclosure, there is provided a manufacturing method of a positive electrode active material for a lithium secondary battery, the manufacturing method including: a step of preparing a core component including a lithium transition metal oxide; a step of preparing a starting material including the core component and a coating precursor; and a step of producing the positive electrode active material including the core component and a coating layer that coats a surface of the core component by thermally treating the starting material.

The step of manufacturing the positive electrode active material may be a process of thermally treating the starting material more than about 280 degrees Celsius and less than about 320 degrees Celsius.

The manufacturing method may further include a step in which the positive electrode active material is analyzed by an X-ray Absorption Spectroscopy and confirmed to satisfy Condition 1. In some embodiments, the positive electrode active material may satisfy Condition 2. The positive electrode active material may satisfy Condition 3.

Also provided is a positive electrode for a lithium secondary battery, the positive electrode comprising: the positive electrode active material; and a sulfide-based solid electrolyte. The electrode may further include a conductive material.

Also provided is a lithium secondary battery comprising the positive electrode active material.

According to the present disclosure, the positive electrode active material for the lithium secondary battery with the excellent coating quality and the manufacturing method of the positive electrode active material may be realized.

According to the present disclosure, the positive electrode active material for the lithium secondary battery and the manufacturing method of the positive electrode active material in which the coating quality is capable of being more easily checked may be realized.

According to the present disclosure, since the side reaction between the positive electrode active material and the sulfide-based solid electrolyte is suppressed, the lithium secondary battery having excellent performance and excellent efficiency may be secured.

The effects of the present disclosure are not limited to the foregoing. It should be understood that the effects of the present disclosure include all effects that can be inferred from the description of the present disclosure.

As discussed, the method and system suitably include use of a controller or processer.

In another embodiment, vehicles are provided that comprise an apparatus as disclosed herein.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows a lithium secondary battery according to the present disclosure;

FIG. 2 shows a positive electrode active material according to the present disclosure;

FIG. 3 shows a result of analyzing the positive electrode active material and a core component according to Manufacturing Example 1 by using an X-ray absorption spectroscopy;

FIG. 4 shows a result of analyzing the positive electrode active material and the core component according to Manufacturing Example 2 by using the X-ray absorption spectroscopy;

FIG. 5 shows a result of analyzing the positive electrode active material and the core component according to comparison Manufacturing Example 1 by using the X-ray absorption spectroscopy;

FIG. 6 shows a result of analyzing the positive electrode active material and the core component according to comparison Manufacturing Example 2 by using the X-ray absorption spectroscopy;

FIG. 7 shows a result of discharging half cells according to embodiment 1-1, embodiment 1-2, embodiment 2-1, and embodiment 2-2;

FIG. 8 shows a result of discharging the half cells according to comparison Example 1-1, Comparison Example 1-2, Comparison Example 2-1, and Comparison Example 2-2; and

FIG. 9 shows an increase rate of discharge capacity and an increase rate of efficiency according to an A/B ratio.

### DETAILED DESCRIPTION OF SPECIFIC EMBODIMENTS

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the present disclosure can be made thorough and complete and that the spirit of the present disclosure can be fully conveyed to those skilled in the art.

Throughout the accompanying drawings, similar reference numerals will be used to describe similar components. In the drawings, the thicknesses of certain lines, layers, components, elements, or features may be exaggerated for clarity. Terms “first”, “second”, and so on can be used to describe various elements, but the elements are not to be construed as being limited to the terms. The terms are used only for the purpose of distinguishing one constituent element from another constituent element. For example, a first element may be termed a second element, and a second element may be termed a first element, without departing from the scope of the present disclosure. Singular expressions include plural expressions unless the context clearly indicates otherwise.

In the present specification, it will also be understood that when a layer, a film, a region, a plate, etc. is referred to as being “on” or “above” another part, it can be “directly on” the other part, or intervening layers may also be present. On the contrary, it will also be understood that when a layer, a film, a region, a plate, etc. is referred to as being “under” or “below” another part, it can be “directly under” the other part, or intervening layers may also be present.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

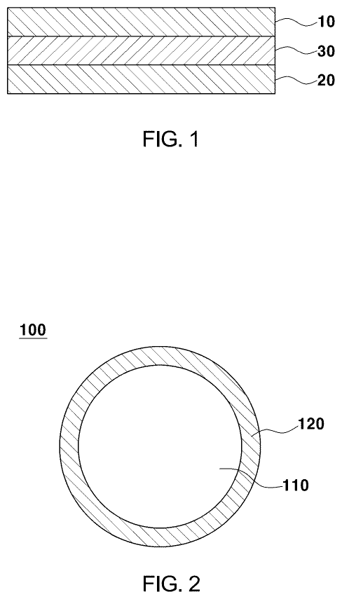

FIG. 1 shows a lithium secondary battery according to the present disclosure. The lithium secondary battery may include an all-solid-state battery. The lithium secondary battery may include a positive electrode 10, a negative electrode 20, and a solid electrolyte layer 30 positioned between the positive electrode 10 and the negative electrode 20.

The positive electrode 10 may include a positive electrode active material, a first sulfide-based solid electrolyte, a first conductive material, a first binder, and so on.

FIG. 2 shows a positive electrode active material 100 according to the present disclosure. The positive electrode active material 100 may include a core component 110 and a coating layer 120 that coats a surface of the core component 110.

The core component 110 may include a lithium transition metal oxide capable of intercalating and disintercalating lithium.

The lithium transition metal oxide may include any lithium transition metal commonly used in the technical field to which the present disclosure pertains. Preferably, the core component 110 may include a lithium transition metal oxide represented by Chemical Formula 1 below.

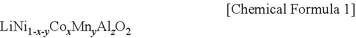

The chemical formula 1 may satisfy 0<x<0.25, 0<y<0.2, 0≤z<0.15, and x+y+z≤0.4.

The core component 110 may be in the form of a secondary particle in which primary particles including the lithium transition metal oxide are agglomerated. The primary particle may refer to a unit of a smallest particle unit which is distinguished as one body when a cross-section of the core component 110 is observed through a device such as a Scanning Electron Microscope (SEM) and so on. The primary particle may be formed of a single grain, or a plurality of grains. The secondary particle may refer to a structure formed by agglomerating the plurality of primary particles. The shape of the secondary particle is not particularly limited, and may be, for example, spherical or elliptical.

The average particle diameter D50 of the core component 110 is not specifically limited, and may be, for example, 1 μm to 20 μm. The average grain diameter D50 of the core component 110 may be measured by a commercially available laser diffraction scattering particle size distribution analyzer, for example, a micro track particle size distribution measurement device. In addition, the average particle diameter may be calculated from 200 particles randomly extracted from an electron micrograph.

The coating layer 120 may prevent the core component 110 from being in contact with the first sulfide-based solid electrolyte in the positive electrode 10, thereby preventing a side reaction from occurring.

The coating layer 120 may include lithium oxide represented by chemical formula 2 below.

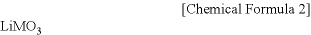

In Chemical Formula 2, the M may include at least one selected from the group consisting of niobium (Nb), tantalum (Ta), boron (B), zirconium (Zr), phosphorus (P), and a combination thereof.

The lithium oxide may conduct lithium ions disintercalated by the core component 110 at the interface between the first sulfide-based solid electrolyte in the positive electrode 10 and the coating layer 120, as well as at the interface between the coating layer 120 and the core component 110.

A manufacturing method of the positive electrode active material 100 may include a step of preparing the core component 110 including the lithium transition metal oxide, a step of preparing a starting material including the core component 110 and a coating precursor, and a step of manufacturing the positive electrode active material 100 including the core component 110 and the coating layer 120 that coats the surface of the core component 110 by thermally treating the starting material.

The step of preparing the starting material may be performed by inputting the core component 110 and the coating precursor into a solvent and mixing the core component 110 and the coating precursor.

The coating precursor may include lithium element and alkoxide of element M. For example, the coating precursor may include lithium ethoxide, niobium ethoxide, and so on.

The type of the solvent is not particularly limited, and may include an organic solvent such as alcohol, a water-based solvent, and so on.

In the present disclosure, to enhance the coating quality of the positive electrode active material 100, the content of the coating layer 120 and the heat treatment condition for the starting material are precisely controlled. Here, the increase in the coating quality may mean that the coating layer 120 uniformly and evenly coats the surface of the core component 110 so that the capacity and the efficiency of the lithium secondary battery are increased when the positive electrode active material 100 is used.

The positive electrode active material 100 may include at least 98% by weight and less than 99% by weight of the core component 110 and more than 1% by weight and equal to or less than 2% by weight of the coating layer 120. In addition, the coating layer 120 may be formed by thermally treating the starting material more than 280 degrees Celsius and less than 320 degrees Celsius. When the content condition of the coating layer 120 and the thermal treatment temperature range for the starting material are satisfied, the discharge capacity and the efficiency of the lithium secondary battery may be increased.

In addition, in the present disclosure, a standard and/or a method for more easily examining the coating quality of the positive electrode active material 100 is proposed. Specifically, the manufacturing method of the positive electrode active material 100 may further include a step in which the positive electrode active material 100 is analyzed by X-ray Absorption Spectroscopy (XAS) and examined as a good product when the positive electrode active material 100 satisfies condition 1 below.

$$0.5 < A / B < 0.8 \qquad [ Condition 1 ]$$

A may be the intensity of an L3 high peak when an Ni L3-edge (L3-edge) spectrum secured by analyzing the positive electrode active material 100 by using the XAS is normalized.

B may be the intensity of an L3 high peak when an Ni L3-edge (L3-edge) spectrum secured by analyzing the core component 110 by using the XAS is normalized.

When the positive electrode active material 100 satisfies condition 1, the discharge capacity and the efficiency of the lithium secondary battery including the positive electrode active material 100 are increased, so that it can be said that the coating quality is excellent. Specifically, when the A/B value of the positive electrode active material 100 is equal to or less than 0.5, the oxidation value of Ni element of the positive electrode active material 100 is low compared to that of the core component 110. Therefore, it can be said that an excessively thick coating layer 120 may reduce the stability and performance of the cell. In addition, when the A/B value of the positive electrode active material 100 is at least 0.8, the oxidation value of the Ni element of the positive electrode active material 100 is high compared to that of the core component 110. Therefore, it can be said that the coating layer 120 may not be properly formed, so that the effect of the coating layer 120 may be insignificant.

Preferably, the positive electrode active material 100 may satisfy condition 2 below.

$$0.6 < A / B < 0.8 \qquad [ Condition 2 ]$$

In condition 2, A and B may be the same as condition 1.

More preferably, the positive electrode active material 100 may satisfy condition 3 below.

$$0.65 \leq A / B \leq 0.77 \qquad [ Condition 3 ]$$

In condition 3, A and B may be the same as condition 1.

The XAS is a method for analyzing a short-range structure, and measures the change in absorption coefficient caused by the transition of the core component electron when X-ray energy is changed and incident on a sample. According to required X-ray energy ranges, the XAS may be classified into a hard XAS of 5 keV or more, a tender XAS of 1 keV to 5 keV, and a soft XAS of equal to or less than 1 keV. The XAS according to the present disclosure may refer to the soft XAS.

A spectrum secured by performing measuring by using the XAS may be classified into an X-ray Absorption Near Edge Structure (XANES) region and an Extended X-ray Absorption Fine Structure (EXAFS) region. In the XANES region, a pre-edge and an absorption edge may be observed, allowing for the confirmation of a change in oxidation number of a specific element.

The Ni L3-edge of the present disclosure may refer to a spectrum in which an X-ray energy range is represented in an 840 eV region to an 885 eV region. The Ni L3-edge may include an L3 low peak that appears in a low energy region and an L3 high peak that appears in an energy region that is higher than the L3 low peak. The intensity of each peak may refer to the oxidation value of the corresponding element. That is, the A/B ratio of condition 1 may refer to a ratio of the oxidation value of nickel contained in the positive electrode active material, which varies based on the presence or absence of the coating layer.

In the present disclosure, when the Li L3-edge spectrum is normalized on the basis of the L3 low peak, the ratio of intensity of the L3 high peak before and after the formation of the coating layer is presented as a standard for evaluating the coating quality. This will be more clearly understood through embodiments and comparison examples to be described later.

The first sulfide-based solid electrolyte may be responsible for the movement of lithium ions within the positive electrode 10.

The type of the first sulfide-based solid electrolyte is not particularly limited, and may include, for example, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (Here, each of m and n is a positive number, and Z is any one of Ge, Zn, and Ga.), Li₂S—GeS₂, Li₂S—SiS₂—Li₃PO₄, Li₂S—SiS₂-LiₓMO_{y} (Here, each of x and y is a positive number, M is any one of P, Si, Ge, B, Al, Ga, and In), Li₁₀GeP₂S₁₂, and so on.

In addition, the first sulfide-based solid electrolyte may be crystalline, amorphous, or a combination thereof.

Preferably, the first sulfide-based solid electrolyte may include a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (Ha includes Cl, Br, or I, and the y satisfies 0<y≤2), Li_{7-z}PS_{6-z} (Ha1_{1-b}Ha2_{b})_{z} (Ha1 and Ha2 are different from each other, each of Ha1 and Ha2 may independently include Cl, Br, or I, and each of b and z satisfies 0<b<1 and 0<z≤2), and a combination thereof.

The first conductive material may include carbon black, conductive graphite, ethylene black, graphene, carbon nanotube, carbon nanofiber, vapor grown carbon fiber, and so on.

The first binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and so on. In the positive electrode 10, the first binder may be present in a particle shape, a linear shape, and so on.

The positive electrode 10 may include 70% by weight to 90% by weight of the positive electrode active material, 10% by weight to 15% by weight of the first sulfide-based solid electrolyte, 1% by weight to 5% by weight of the first conductive material, and 1% by weight to 5% by weight of the first binder. However, the content of each content may be appropriately adjusted in consideration of the capacity, the efficiency, and other requirements of the target all-solid-state battery.

The thickness of the positive electrode 10 is not particularly limited, but may be 1 μm to 100 μm. The thickness of the positive electrode 10 may refer to an average value when the thickness of the positive electrode 10 is measured at five points. In addition, the thickness of the positive electrode 10 may refer to the thickness of the positive electrode 10 when the lithium secondary battery is discharged.

According to a first embodiment of the present disclosure, the negative electrode 20 may be a composite negative electrode including a negative electrode active material, a second sulfide-based solid electrolyte, a second conductive material, a second binder, and so on.

The negative electrode active material is not specifically limited, and may include, for example, a carbon active material or a metal active material.

The carbon active material may include mesocarbon microbeads (MCMB), graphite such as highly oriented pyrolytic graphite (HOPG), or amorphous carbon such as hard carbon or soft carbon.

The metal active material may include In, Al, Si, Sn, or an alloy including at least two of these elements.

The negative electrode active material may be formed by compositing the carbon active material and the metal active material. For example, the metal active material may be coated on a surface of the carbon active material, or the carbon active material may be coated on a surface of the metal active material.

The second sulfide-based solid electrolyte may be responsible for the movement of lithium ions within the negative electrode 20 and may be the same as or different from the first sulfide-based solid electrolyte. The type of the second sulfide-based solid electrolyte is not particularly limited, and may include, for example, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (Here, each of m and n is a positive number, and Z is any one of Ge, Zn, and Ga.), Li₂S—GeS₂, Li₂S—SiS₂—Li₃PO₄, Li₂S—SiS₂-LiₓMO_{y} (Here, each of x and y is a positive number, M is any one of P, Si, Ge, B, Al, Ga, and In), Li₁₀GeP₂S₁₂, and so on.

In addition, the second sulfide-based solid electrolyte may be crystalline, amorphous, or a combination thereof.

Preferably, the second sulfide-based solid electrolyte may include a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (Ha includes Cl, Br, or I, and the y satisfies 0<y≤2), Li_{7-z}PS_{6-z} (Ha1_{1-b}Ha2_{b})_{z} (Ha1 and Ha2 are different from each other, each of Ha1 and Ha2 may independently include Cl, Br, or I, and each of b and z satisfies 0<b<1 and 0<z≤2), and a combination thereof.

The second conductive material may include carbon black, conductive graphite, ethylene black, graphene, carbon nanotube, carbon nanofiber, vapor grown carbon fiber, and so on.

The second conductive material may be the same as or different from the first conductive material.

The second binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and so on. In the negative electrode 20, the second binder may be present in a particle shape, a linear shape, and so on.

The second binder may be the same as or different from the first binder.

The negative electrode 20 may include 80% by weight to 85% by weight of the negative electrode active material, 10% by weight to 15% by weight of the second sulfide-based solid electrolyte, and 1% by weight to 5% by weight of the second binder. However, each content of the components may be appropriately adjusted in consideration of the capacity, the efficiency, and so on of the target all-solid-state battery.

The thickness of the negative electrode 20 is not particularly limited but may range from 1 μm to 100 μm. The thickness of the negative electrode 20 may be determined as an average value measured at five different points. In addition, the thickness of the negative electrode 20 may refer to the thickness of the negative electrode 10 when the lithium secondary battery is discharged.

According to a second embodiment of the present disclosure, the negative electrode 20 may include lithium metal or a lithium metal alloy.

The lithium metal alloy may include an alloy of lithium and a metal or a metalloid alloyable with lithium. The metal or the metalloid alloyable with lithium may include Si, Sn, Al, Ge, Pb, Bi, Sb and so on.

According to a third embodiment of the present disclosure, the negative electrode 20 may not include a negative electrode active material any component substantially performing the same role. When the all-solid-state battery is charged, lithium ions moved from the positive electrode 10 may be precipitated and stored in a form of lithium metal between the negative electrode 20 and a negative electrode current collector (not illustrated).

The negative electrode 20 may include amorphous carbon and a metal alloyable with lithium.

The amorphous carbon may include at least one selected from the group consisting of furnace black, acetylene black, Ketjen black, graphene, and a combination thereof.

The metal may include at least one selected from the group consisting of gold (Au), platinum (Pt), palladium (Pd), silicon (Si), silver (Ag), aluminum (Al), bismuth (Bi), tin (Sn), zinc (Zn), and a combination thereof.

The negative electrode 20 may include 90% by weight to 99% by weight of the amorphous carbon and 1% by weight to 10% by weight of the metal. However, each content of the components may be appropriately adjusted in consideration of the capacity, the efficiency, and so on of the target all-solid-state battery.

The solid electrolyte layer 30 may be a sheet shape having at least two main surfaces facing each other. Each of these surfaces may include not only a mathematical plane but also a certain curved surface in a part thereof, and may exhibit unevenness generated during the production of the solid electrolyte layer 30. Therefore, the sheet shape is not limited to a thin rectangular parallelepiped.

In the solid electrolyte layer 30 having the sheet shape, the distance between the two facing main surfaces described above corresponds to the thickness of the solid electrolyte layer 30. In the solid electrolyte layer 30, the length in a first direction (for example, a width direction) orthogonal to the thickness direction is longer than the thickness. In addition, in the solid electrolyte layer 30, the length in a second direction (for example, the length direction) orthogonal to each of the thickness direction and the first direction is longer than the thickness.

The thickness of the solid electrolyte layer 30 is not particularly limited but may range from 1 μm to 100 μm. The thickness of the solid electrolyte layer 30 may refer to an average value derived from measurements at five different points.

The solid electrolyte layer 30 may include a third sulfide-based solid electrolyte having lithium-ion conductivity, a third binder, and so on.

The third sulfide-based solid electrolyte may be the same as or different from the first sulfide-based solid electrolyte and/or the second sulfide-based solid electrolyte. The type of the third sulfide-based solid electrolyte is not particularly limited, and may include, for example, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (Here, each of m and n is a positive number, and Z is any one of Ge, Zn, and Ga.), Li₂S—GeS₂, Li₂S—SiS₂—Li₃PO₄, Li₂S—SiS₂-LiₓMO_{y} (Here, each of x and y is a positive number, M is any one of P, Si, Ge, B, Al, Ga, and In), Li₁₀GeP₂S₁₂, and so on.

In addition, the third sulfide-based solid electrolyte may be crystalline, amorphous, or a combination thereof.

Preferably, the third sulfide-based solid electrolyte may include a sulfide-based solid electrolyte having an argyrodite crystal structure. The sulfide-based solid electrolyte having the argyrodite crystal structure may include at least one selected from the group consisting of Li_{7-y}PS_{6-y}Ha_{y} (Ha includes Cl, Br, or I, and the y satisfies 0<y≤2), Li_{7-z}PS_{6-z} (Ha1_{1-b}Ha2_{b})_{z} (Ha1 and Ha2 are different from each other, each of Ha1 and Ha2 may independently include Cl, Br, or I, and each of b and z satisfies 0<b<1 and 0<z≤2), and a combination thereof.

The third binder may include Butadiene rubber, nitrile butadiene rubber, hydrogenated nitrile butadiene rubber, polyvinylidene fluoride (PVDF), polytetrafluoroethylene (PTFE), carboxymethyl cellulose (CMC), and so on. In the solid electrolyte layer 30, the third binder may be present in a particle shape, a linear shape, and so on.

The third binder may be the same as or different from the first binder and/or the second binder.

Hereinafter, the present disclosure will be described in more detail through the following embodiments. The following embodiments serve merely to exemplarily describe the present disclosure, and are not intended to limit the scope of the present disclosure.

### Manufacturing Example 1

A lithium precursor, a nickel precursor, a cobalt precursor, and a manganese precursor were weighed to achieve the composition of LiNi_{0.8}Co_{0.1}Mn_{0.1}O₂ and were then dissolved in a solvent to prepare the raw material. The raw material was sintered for about 10 hours at about 750 degrees Celsius, so that a core component containing a lithium transition metal oxide was secured.

Lithium ethoxide and niobium ethoxide were weighed for the composition of LiNbO₃ and were input into a solvent together with the core component and then were mixed, so that a starting material was prepared. The lithium ethoxide and the niobium ethoxide were input by adjusting the content such that the content of a coating layer in a completed positive electrode active material is about 2% by weight. The starting material was dried at about 80 degrees Celsius for about 12 hours by using a vacuum oven. The dried starting material was thermally treated at about 300 degrees Celsius for about 5 hours, resulting in the positive electrode active material including the core component and the coating layer that coats the core component.

### Manufacturing Example 2

Except that the content of the coating layer was adjusted to 1.5% by weight and the starting material was thermally treated at about 280 degrees Celsius for about 6 hours, the positive electrode active material was manufactured in the same manner as in Manufacturing Example 1.

### Comparative Manufacturing Example 1

Except that the content of the coating layer was adjusted to 1% by weight and the starting material was thermally treated at about 250 degrees Celsius for about 7 hours, the positive electrode active material was manufactured in the same manner as in Manufacturing Example 1.

### Comparative Manufacturing Example 2

Except that the content of the coating layer was adjusted to 0.5% by weight and the starting material is thermally treated at about 320 degrees Celsius for about 5 hours, the positive electrode active material was manufactured in the same manner as in Manufacturing Example 1.

Each positive electrode active material according to Manufacturing Example 1, Manufacturing Example 2, Comparative Manufacturing Example 1, and Comparative Manufacturing Example 2 was attached to each copper holder having high conductivity with a carbon tape. In order to prevent X-ray absorption by oxygen in the atmosphere, the holder was inserted into a vacuum chamber and a vacuum state was maintained. Each positive electrode active material was irradiated with X-rays, and the Ni L3-edge region of 840 eV to 885 eV was scanned. After obtaining an absorption spectrum of the scanned region, the background was removed, and normalization was performed based on the L3 low peak. In addition, in the same manner, the X-ray absorption spectroscopy was performed on each core components used in Manufacturing Example 1, Manufacturing Example 2, Comparative Manufacturing Example 1, and Comparative Manufacturing Example 2.

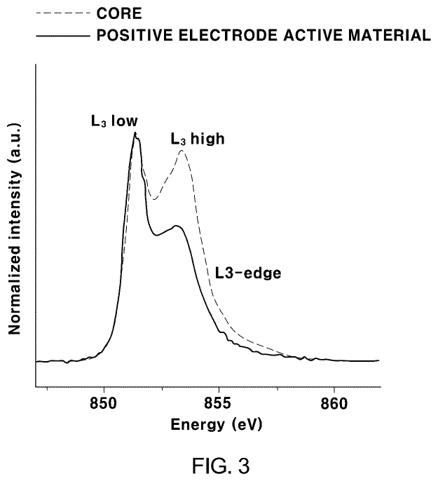

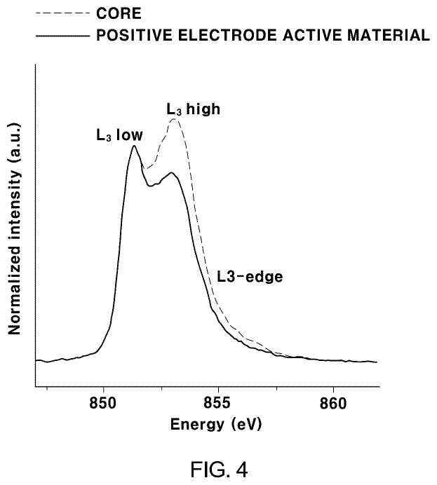

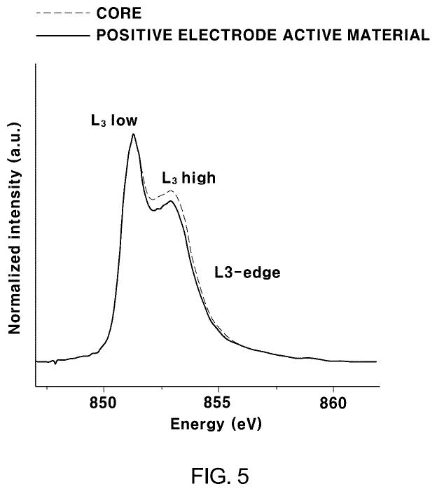

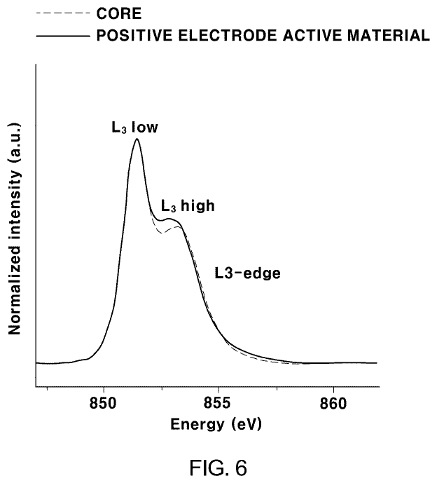

FIG. 3 shows a result of analyzing the positive electrode active material and the core component according to Manufacturing Example 1 by using the X-ray absorption spectroscopy. FIG. 4 shows a result of analyzing the positive electrode active material and the core component according to Manufacturing Example 2 by using the X-ray absorption spectroscopy. FIG. 5 shows a result of analyzing the positive electrode active material and the core component according to Comparative Manufacturing Example 1 by using the X-ray absorption spectroscopy. FIG. 6 shows a result of analyzing the positive electrode active material and the core component according to Comparative Manufacturing Example 2 by using the X-ray absorption spectroscopy.

Each ratio of intensity of the L3 high peak of the positive electrode active material and the core component according to each result is shown in Table 1 below.

### Example 1-1

The positive electrode active material, the sulfide-based solid electrolyte, and the conductive material according to Manufacturing Example 1 were mixed with a mass ratio of about 69:29:2, so that a positive electrode material in a powder state was secured. A positive electrode in a pellet state was manufactured by pressing the positive electrode material. The loading amount of the positive electrode was 13 mg/cm².

A solid electrolyte layer in a pellet state was formed by pressing the sulfide-based solid electrolyte to about 10 MPa. The positive electrode was placed on a first surface of the solid electrolyte layer, and lithium metal was attached to an opposite surface of the positive electrode. The positive electrode, the solid electrolyte layer, and the lithium metal were then pressed to about 32 MPa for about 5 minutes, resulting in the manufacture of a half cell.

### Example 1-2

Except that the core component used in Manufacturing Example 1 was used instead of the positive electrode active material, a half cell was manufactured in the same manner as in Example 1-1.

### Example 2-1

Except that the positive electrode active material according to Manufacturing Example 2 was used, a half cell was manufactured in the same manner as in Example 1-1.

### Embodiment 2-2

Except that the core component used in Manufacturing Example 2 was used instead of the positive electrode active material, a half cell was manufactured in the same manner as in Example 1-1.

### Comparative Example 1-1

Except that the positive electrode active material according to Comparative Manufacturing Example 1 was used, a half cell was manufactured in the same manner as in Example 1-1.

### Comparative Example 1-2

Except that the core component used in Comparative Manufacturing Example 1 was used instead of the positive electrode active material, a half cell was manufactured in the same manner as in Example 1-1.

### Comparative Example 2-1

Except that the positive electrode active material according to Comparative Manufacturing Example 2 was used, a half cell was manufactured in the same manner as in Example 1-1.

### Comparative Example 2-2

Except that the core component used in Comparative Manufacturing Example 2 was used instead of the positive electrode active material, a half cell was manufactured in the same manner as in Example 1-1.

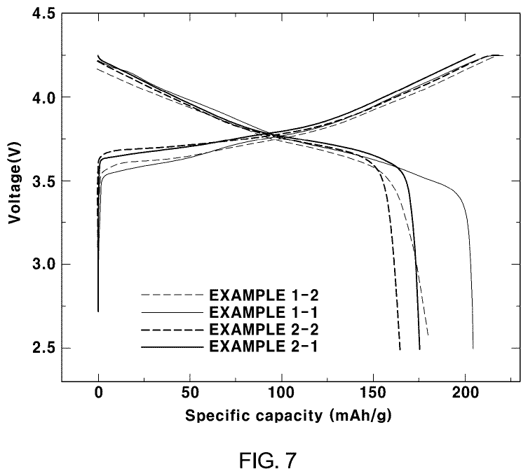

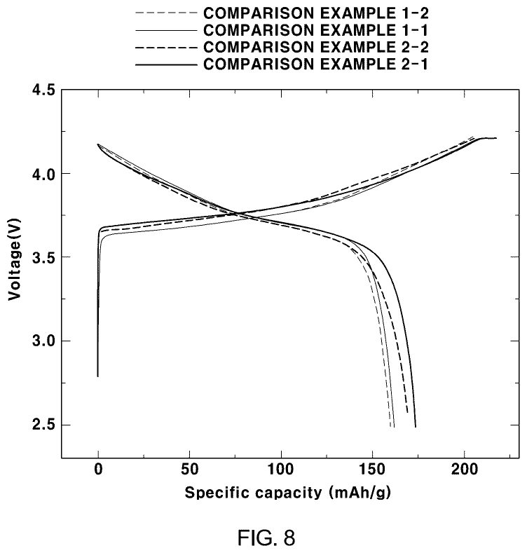

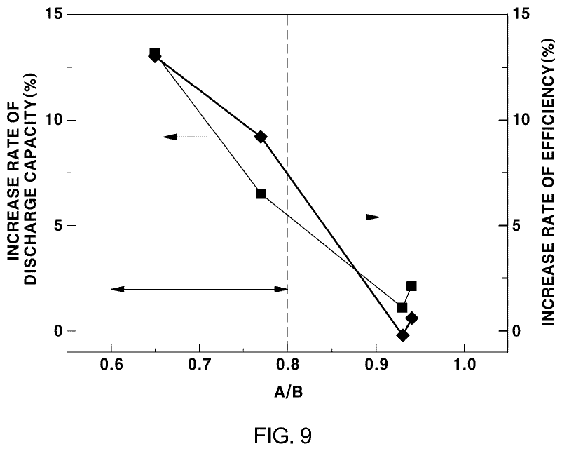

Each half cell according to Example 1-1, Example 1-2, Example 2-1, Example 2-2, Comparative Example 1-1, Comparative Example 1-2, Comparative Example 2-1, and Comparative Example 2-2 was charged in a constant current (CC) mode to −4.25 V with 0.1 C at about 30 degrees Celsius, and then was discharged in the CC mode to 2.5 V with 0.1 C. The results are as shown in FIG. 7 to FIG. 9. FIG. 7 shows a result of discharging the half cells according to Example 1-1, Example 1-2, Example 2-1, and Example 2-2. FIG. 8 shows a result of discharging the half cells according to Comparative Example 1-1, Comparative Example 1-2, Comparative Example 2-1, and Comparative Example 2-2. FIG. 9 shows an increase rate of discharge capacity and an increase rate of efficiency according to the A/B ratio. In addition, the discharge capacity and the efficiency are illustrated in Table 1 below. In Table 1 below, the results of Example 1-1 and 1-2 are referred to as Example 1, the results of Example 2-1 and 2-2 are referred to as Example 2, the results of Comparative Examples 1-1 and Comparative Examples 1-2 are referred to as Comparative Example 1, and the results of Comparative Examples 2-1 and Comparative Examples 2-2 are referred to as Comparative Example 2.

TABLE 1

| | | | | | Comparative | | Comparative | |
|---|---|---|---|---|---|---|---|---|
| | Example 1 | | Example 2 | | Example 1 | | Example 2 | |
| Item | 1-1 | 1-2 | 2-1 | 2-2 | 1-1 | 1-2 | 2-1 | 2-2 |
| Coating | 2.0 | — | 1.5 | — | 1.0 | — | 0.5 | — |
| Amount | | | | | | | | |
| [Weight %] | | | | | | | | |
| Thermal | 300° C./ | | 280° C./ | | 250° C./ | | 320° C./ | |
| Treatment | 5 hours | | 6 hours | | 7 hours | | 5 hours | |
| Condition | | | | | | | | |
| Ni | 0.6 | 0.92 | 0.87 | 1.13 | 0.70 | 0.75 | 0.61 | 0.65 |
| oxidation | | | | | | | | |
| value¹⁾ | | | | | | | | |
| A/B | 0.65 | | 0.77 | | 0.93 | | 0.94 | |
| Discharge | 204.3 | 180.4 | 175.2 | 164.5 | 162.0 | 160.2 | 173.8 | 170.2 |
| Capacity | | | | | | | | |
| [mAh/g] | | | | | | | | |
| Initial | 94.0 | 81.0 | 85.0 | 75.8 | 76.1 | 76.2 | 80.0 | 79.4 |
| Efficiency | | | | | | | | |
| [%] | | | | | | | | |

1) the Ni oxidation value refers to the intensity of the L3 high peak.

Referring to Table 1 and FIG. 9, it can be seen that the synergistic effect due to the presence of the coating layer is minimal in Comparative Example 1 and Comparative Example 2 comparing to Example 1 and Example 2 which satisfy the condition of A/B presented in the present disclosure and in which the discharge capacity and the efficiency are increased significantly as the coating layers were formed. In consideration of this, when the positive electrode active material satisfies the condition that A/B, as presented in the present disclosure, is more than 0.5 and less than 0.8, the coating quality may be evaluated as excellent.

Although embodiments of the present disclosure have been described in detail, the scope of the prevent disclosure is not limited to the embodiments, and various modifications and improvements devised by those skilled in the art using the fundamental concept of the present disclosure, which is defined by the appended claims, may further fall within the scope of the present disclosure.

What is claimed is:

1. A positive electrode active material for a lithium secondary battery, the positive electrode active material comprising:
a core component comprising a lithium transition metal oxide; and
a coating layer that coats a surface of the core component,
wherein the positive electrode active material satisfies Condition 1 below,
$$0.5 < A / B < 0.8 \qquad [ Condition 1 ]$$
wherein A is an intensity of an L3 high peak when a Ni L3-edge spectrum secured by analyzing the positive electrode active material by using an X-ray absorption spectroscopy is normalized, and
wherein B is an intensity of an L3 high peak when a Ni L3-edge spectrum secured by analyzing the core component by using the X-ray absorption spectroscopy is normalized.

2. The positive electrode active material of claim 1, wherein the core component comprises the lithium transition metal oxide represented by Chemical Formula 1 below, 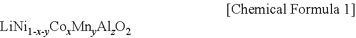
wherein Chemical Formula 1 satisfies 0<x<0.25, 0<y<0.2, 0≤z<0.15, and x+y+z≤0.4.

3. The positive electrode active material of claim 1, wherein the coating layer comprises a compound represented by Chemical Formula 2 below, 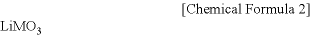
wherein in Chemical Formula 2, the M comprises at least one selected from the group consisting of niobium (Nb), tantalum (Ta), boron (B), zirconium (Zr), phosphorus (P), and a combination thereof.

4. The positive electrode active material of claim 1, wherein the positive electrode active material comprises:
at least about 98% by weight and less than about 99% by weight of the core component; and
more than about 1% by weight and equal to or less than about 2% by weight of the coating layer.

5. The positive electrode active material of claim 1, wherein the positive electrode active material satisfies Condition 2,
$$0.6 < A / B < 0.8 . \qquad [ Condition 2 ]$$

6. The positive electrode active material of claim 5, wherein the positive electrode active material satisfies Condition 3,
$$0.65 \leq A / B \leq 0.77 . \qquad [ Condition 3 ]$$

7. The positive electrode active material of claim 1, wherein the core component is in the form of a secondary particle in which primary particles including the lithium transition metal oxide are agglomerated.

8. The positive electrode active material of claim 7, wherein the primary particles are formed of a single grain or a plurality of grains.

9. The positive electrode active material of claim 1, wherein the average particle diameter (D50) of the core component is between about 1 μm and about 20 μm.

10. A positive electrode for a lithium secondary battery, the positive electrode comprising:
the positive electrode active material of claim 1; and
a sulfide-based solid electrolyte.

11. The positive electrode of claim 10 further comprising a conductive material.

12. A lithium secondary battery comprising the positive electrode active material of claim 1.

13. A manufacturing method of a positive electrode active material for a lithium secondary battery, the manufacturing method comprising:
preparing a core component comprising a lithium transition metal oxide;
preparing a starting material comprising the core component and a coating precursor; and
producing the positive electrode active material comprising the core component and a coating layer that coats a surface of the core component by thermally treating the starting material,
wherein the manufacturing method satisfies Condition 1 below,
$$0.5 < A / B < 0.8 \qquad [ Condition 1 ]$$
A is an intensity of an L3 high peak when a Ni L3-edge spectrum secured by analyzing the positive electrode active material by using an X-ray absorption spectroscopy is normalized, and
B is an intensity of an L3 high peak when a Ni L3-edge spectrum secured by analyzing the core component by using the X-ray absorption spectroscopy is normalized.

14. The manufacturing method of claim 13, wherein the manufacturing method satisfies Condition 2,
$$0.6 < A / B < 0.8 . \qquad [ Condition 2 ]$$

15. The manufacturing method of claim 13, wherein the manufacturing method satisfies Condition 3,
$$0.65 \leq A / B \leq 0.77 . \qquad [ Condition 3 ]$$

16. The manufacturing method of claim 13, wherein the step of producing the positive electrode active material is a process of thermally treating the starting material more than about 280 degrees Celsius and less than about 320 degrees Celsius.

17. The manufacturing method of claim 13, wherein the core component comprises the lithium transition metal oxide represented by Chemical Formula 1 below, 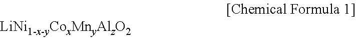
Chemical Formula 1 satisfies 0<x<0.25, 0<y<0.2, 0≤z<0.15, and x+y+z≤0.4.

18. The manufacturing method of claim 13, wherein the coating layer comprises a compound represented by Chemical Formula 2 below, 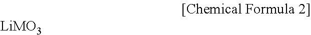
In Chemical Formula 2, the M comprises at least one selected from the group consisting of niobium (Nb), tantalum (Ta), boron (B), zirconium (Zr), phosphorus (P), and a combination thereof.

19. The manufacturing method of claim 13, wherein the positive electrode active material comprises:
at least about 98% by weight and less than about 99% by weight of the core component; and
more than about 1% by weight and equal to or less than about 2% by weight of the coating layer.

20. The manufacturing method of claim 13, further comprising a step in which the positive electrode active material is analyzed by the X-ray Absorption Spectroscopy and confirmed to satisfy Condition 1.
